(19) United States
(12) Patent Application Publication
(10) Pub. No.: US 2024/0320615 A1
(43) Pub. Date: Sep. 26, 2024

(54) METHOD AND SYSTEM FOR DETERMINING AND PROVIDING PRODUCT AVAILABILITY

(71) Applicant: YAHOO ASSETS LLC, New York, NY (US)

(72) Inventors: Eric BAX, Sierra Madre, CA (US); Lisa GIAFFO, Pasadena, CA (US); Melissa GERBER, Rancho Mission Viejo, CA (US); Tanisha SHARMA, Los Angeles, CA (US); Nikki THOMPSON, Bloomfield, NJ (US); Will WAGNER, Costa Mesa, CA (US)

(21) Appl. No.: 18/187,940

(22) Filed: Mar. 22, 2023

(51) Int. Cl. G06Q 10/087

(52) U.S. Cl. CPC G06Q 10/087

(57) ABSTRACT

In some aspects, the techniques described herein relate to a method including obtaining purchase history data for a plurality of users within a group, the purchase history corresponding to at least one product; determining a first product availability corresponding to the at least one product based on the purchase history data; transmitting, to a User Equipment (UE) of a user of the plurality of users, a notification including the first product availability; obtaining updated purchase history data, the updated purchase history data corresponding to the at least one product; determining a second product availability corresponding to the at least one product based on the updated purchase history data; determining a product availability change based on the first product availability and the second product availability; and modifying user rights of the user based on the product availability change.

### BACKGROUND

Product availability can be impacted by a myriad of factors such as supply chain issues, production issues, recalls, sudden increase in the popularity of the goods, among others. As product shortages become apparent, consumers search for ways to discover when and where the goods may become available and to acquire the products outright as soon as they become available. Increasingly, social networks have become the go-to sources of product availability information for the user-consumer within these platforms. However, the amplification power of social networks is such that when a consumer publicizes a product shortage, other consumers are incited to buy beyond their needs and hoard the products, which further exacerbates the shortages. In some instances, publicizing the availability of a specific product at a specific source can lead to a run on that source while other sources may have plentiful supply of the product.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating components of a notification engine according to some embodiments.

FIG. 2 is a flow diagram illustrating a method for managing user rights in a social network platform according to some embodiments.

FIG. 3 is a block diagram illustrating an example of a network within which the systems and methods disclosed herein could be implemented according to some embodiments.

FIG. 4 is a block diagram of a device according to some embodiments.

### DETAILED DESCRIPTION

The present disclosure provides systems and methods for determining product availability from purchase history data and managing user rights for dissemination of product availability within a social network platform.

In embodiments, a social network platform is provided for users to connect with other users and, among other things, share and receive information about a product including product availability, vendors (or other source), and prices. In some embodiments, a user's right to share and receive information within the platform can be based on that user's purchasing patterns, the availability of the purchased products, and the user's propensity for disseminating information outside the platform or outside a predetermined group or groups within the platform. For example, in some embodiments, user rights corresponding to a user can be limited based on whether a product previously purchased by the user became unavailable after the user purchased it.

In some embodiments, users within the platform can be organized into groups. In some embodiments, the groups can be determined by geographical location (e.g., a neighborhood, city, county, etc.). In some embodiments, the groups can be determined by an affinity to a specific product (e.g., X-brand televisions) or category of products (e.g., baby formula or appliances). In some embodiments, users within groups are more likely to have accurate information regarding a product in their geographical location than general users. In some embodiments, the platform incentivizes the users within a group to only share product availability data within the group by allowing or limiting the alerts or notifications a user may receive regarding product availability and/or allowing or limiting a user's ability to submit product availability data within the group.

In some embodiments, a user can start a group and invite other users to join. In some embodiments, the user can search for a group that is accepting new members and ask to join. In some embodiments, the platform can automatically add the user to a group. In some embodiments, the platform can determine which group the user should belong to based on location or similar purchase patterns with existing group members.

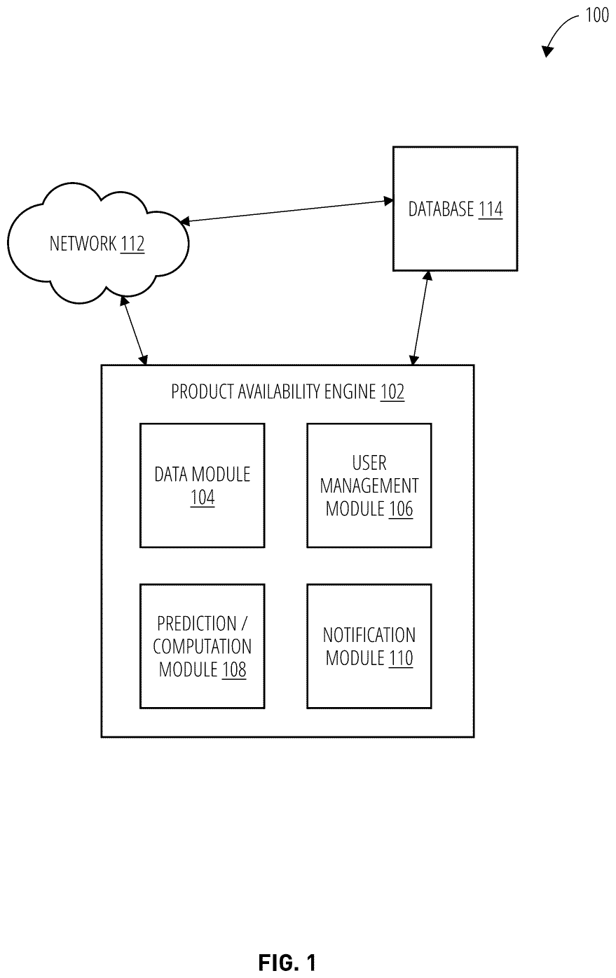

In some embodiments, potential users (e.g., outside the platform) can join the platform upon receiving an invite. In some embodiments, when the user creates an account in the platform the platform will automatically assign the user a user ID. In some embodiments, any user information corresponding to the user can be stored as user data in a database (e.g., database 114 as discussed in relation FIG. 1).

In some embodiments, the user can grant the platform access to their purchase history, bank accounts, credit card accounts, and the like. In some embodiments, the access can be limited to specific products of types of payment. In some embodiments, the user may grant the platform access to their communications (e.g., messages, emails, phone calls, and the like). In those embodiments, the platform may extract the purchase history data and store it as part of the user data. In some embodiments, the user can also third parties to maintain applications in a device of the user that forwards the purchase information to the platform. In those embodiments, the third-party application or the platform can strip personally identifiable information from the purchase history data before storing, analyzing, or forwarding it to another party. In some embodiments, the platform can maintain anonymized purchase history data for a specific group based on the purchase history of the group's members.

In some embodiments, for each group, the platform can gather and store purchase history data from some or all of the members within the group. In some embodiments, the platform can then analyze the data to predict product availability of a given product in the form of product availability data. In some embodiments, the platform can predict product availability based on whether a product was bought within a specified time period from a vendor. If so, in some embodiments, the platform can predict that the product is in stock.

In some embodiments, to predict product availability the platform can analyze the purchase history data to estimate the distribution of gaps between purchases of each product for each vendor (e.g., by skipping time periods in which the vendor is unavailable, for example, if a vendor is a store is closed for the night). In some embodiments, if the time from the most recent purchase exceeds some specified portion of the gaps for a product and vendor, then the platform can predict that the product is unavailable at the source. In some embodiments, if there is insufficient data to make a prediction the platform can adjust for time of day, day of week, paycheck cycle, and annual seasonality.

In some embodiments, the platform can request feedback from the user related to a product availability prediction. For example, in some embodiments, the platform can prompt the user to indicate whether a product is in stock at a specific vendor. In some embodiments, the platform may determine the geographical location of the user and cross-reference it with the geographical location of vendors and prompt the user when the user is nearby the vendor.

In some embodiments, the users can submit observations or reports regarding product availability on their own initiative. In those embodiments, the platform can augment the product availability prediction using the report data to update the prediction. In some embodiments, the platform can use the report data to set thresholds for time periods for a specific product or vendors. In some embodiments, the user can submit a report from a user equipment (UE) or device. In some embodiments, to submit a report in the platform, the user can access the platform and select a product, specify whether the product is available or absent, specify an product quantity, and a product price. In some embodiments, the platform can gather a location and report time from the UE. Then, in some embodiments, the platform can create a report record in the form of report data and store the report data in a database (e.g., database 114).

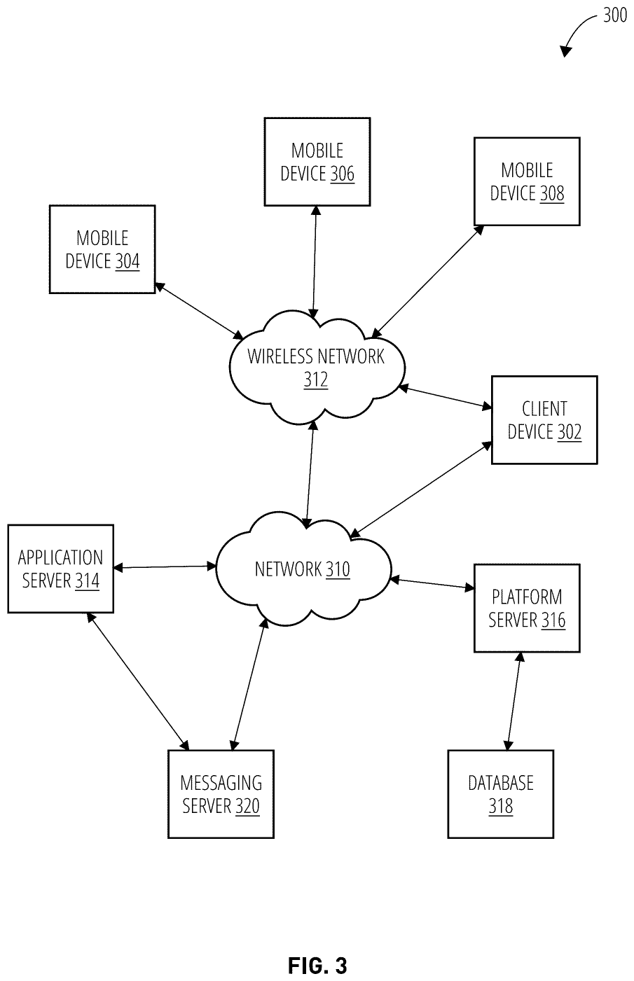

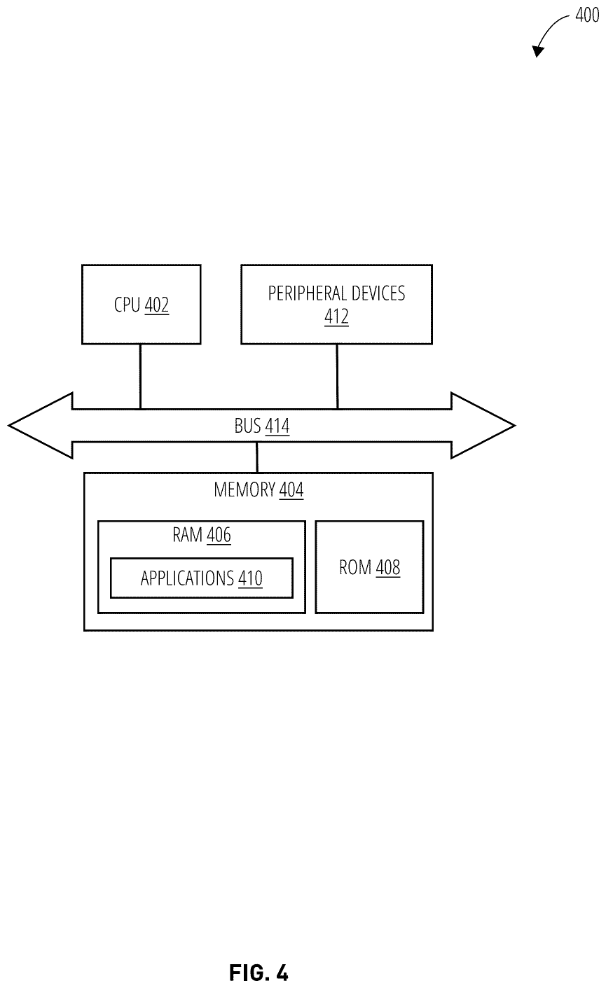

In some embodiments, to update product availability the platform can generate a product availability delta record. In some embodiments, the platform can generate the product availability delta record by obtaining system time from a UE or from an internal time of the device implementing the platform (e.g., device 400 in FIG. 4, or servers 314, 316, or 320 from FIG. 3). Then, in some embodiments, the platform can obtain all report data that predates the system time. In some embodiments, the platform can obtain all report data that predates the system time and occurs after a last product availability delta record, if existing. Then, in some embodiments, for each record in the obtained record data, the platform updates the product availability data by determining a group ID(s) for at least one user ID, checking for another entry in the product availability data with the same product ID, location, and/or group ID, and adding the product availability delta record to the product availability data if no other entry exists with the same product ID, location, and/or group ID. In some embodiments, if another entry already exists, then the platform compares report times and if the product availability delta record is more recent than the existing entry, the platform replaces the existing entry with the product availability delta record.

In some embodiments, the platform can transmit an alert or notifications message to users about the availability of goods based on alert preferences provided by the user. In some embodiments, users can register for alerts on specific goods at specific vendors, or on any vendor within a geographic area. In some embodiments, the alerts or notifications can be transmitted from the platform to a UE of the user via email, text, phone call, application notifications, and the like.

In some embodiments, users can visit a website or interact with a mobile application to query for product availability data from the platform corresponding to specific goods. In some embodiments, the platform can display the product availability on a map or in a list of vendors with contact information for the vendors. In those embodiments, the user can contact the vendors to confirm availability or to reserve the product if available. In some embodiments, the user can provide a report or observation to the platform corroborating or submitting a change to the product availability data provided by the platform. In some embodiments, the notifications can be specific to a group. In some embodiments, the notifications can be specific to product shortages in general, in a geographic area, from specific vendors, or from specific vendors within a specific geographic area.

In some embodiments, a user can query the platform by specifying query parameters such as product IDs, product categories, geographic locations, and/or price limits. Then, in some embodiments, the platform can determine the group IDs for the user via a data request to the database comprising the user data, and obtain product availability data based on product ID, location, and/or group ID. In some embodiments, the platform can transmit a message with the product availability data to the user.

In some embodiments, the user can submit a standing query with query parameters such as product IDs, product categories, geographic locations, and/or price limits. Then, in some embodiments, the platform can determine the group IDs for the user via a data request to the database comprising the user data, and generate a standing query record and stores it as part of standing query data in the database.

In some embodiments, the platform determines whether to respond to standing queries after receiving product availability updates (e.g., after product availability delta record is entered). In those embodiments, the platform determines any standing queries from the standing query data that have a group ID that matches the group ID, product ID, and location of the product availability delta record. In some embodiments, for each standing query matching the product availability delta record, the system can transmit an alert message to the user indicated by the user ID in the standing query record. In some embodiments, when transmitting an alert message or notification message to a user, the platform can determine the user's notification or alert preferences and follow the user's preference.

In some embodiments, each user within the platform can have a set of user rights. In some embodiments, the user rights correspond to a user's ability to receive notifications, submit reports or observations, or otherwise be privy to activity within a group. For example, in some embodiments, the platform can limit alerts or other information in response to queries from some users. In some embodiments, the limitation can take the form of randomly not sharing some information or production about product availability. In some embodiments, user rights limitations can be based on the tendency of the user's purchases of a product at a vendor (e.g., a product-vendor pair) to lead to the products' unavailability at that vendor soon after the purchase, in comparison to the same tendency for other users regarding the same product-vendor pair. In some embodiments, such user rights limitation may discourage users from actions that create that tendency, such as hoarding, sharing data with a group that includes many hoarders, or sharing data very widely, for example by joining multiple groups.

In some embodiments, the platform can collect and report data on product prices as well as availability. Then, in some embodiments, users can receive notification messages about price changes or perform queries to find prices of products at different vendors. In some embodiments, users can specify alerts for a new low price or for a vendor offering a new low price within a geographic area. In some embodiments, users can query for the lowest-price source for a product among a set of vendors. In some embodiments, users can query the platform for a set of products and specified set of vendors, and the platform can respond with a list of products for each vendor comprising the products for which the vendor has the lowest price among the set of vendors.

In some embodiments, the platform can offer users coupons or discounts for specific product-vendor pairs. In some embodiments, the offers can be based on group membership and can be targeted to users or groups based on the purchase history data.

In some embodiments, the platform can use purchase history data and report data collected from the group over time to predict when products will become available from vendors where they are currently estimated to be unavailable. In some embodiments, the prediction can be based on the distribution of times when the product became available in the past. For example, in some embodiments, if the platform collects group data showing that a product becomes available at a vendor every other Tuesday, then it can predict that the pattern will continue. Then, in some embodiments, the platform can send notification messages to users about possible availability changes and/or respond to user queries by adding predicted availability times to estimates of unavailability. In some embodiments, the platform can predict based on the purchase history data and/or report data when products will become unavailable at different vendors.

In some embodiments, the platform may reward users for sharing their data (e.g., user data, purchase history data, or report data) and charge others for accessing the group's data. For example, in some embodiments, the system may collect a fee from users, then pay some group members for their data based on Shapley values, by assigning a value to the use of data. In some embodiments, the platform can assign value to a user's data by estimating that an alert to a user followed by a purchase from the user is worth some fraction of the purchase price to the user.

In some aspects, the techniques described herein relate to a method including obtaining purchase history data for a plurality of users within a group, the purchase history corresponding to at least one product; determining a first product availability corresponding to the at least one product based on the purchase history data; transmitting, to a User Equipment (UE) of a user of the plurality of users, a notification including the first product availability; obtaining updated purchase history data, the updated purchase history data corresponding to the at least one product; determining a second product availability corresponding to the at least one product based on the updated purchase history data; determining a product availability change based on the first product availability and the second product availability; and modifying user rights of the user based on the product availability change.

In some aspects, obtaining updated purchase history data further can comprise obtaining report data corresponding to product availability of the at least one product.

In some aspects, determining the second product availability can be based on the updated purchase history data and the report data.

In some aspects, the user rights can correspond to the user's ability to share information within the group.

In some aspects, modifying the user rights comprises limiting a capability selected from the group consisting of a user's ability to share and receive information, a number of queries and standing queries a user can submit within a time period, and a number of responsive results to user's queries.

In some embodiments, modifying the user rights can be further based on an information usefulness score corresponding to the user.

In some aspects, the information usefulness score can be based on whether the user shares more or less product availability information than other users from the plurality of users, the utility of information, similarity to information shared by other users, and timeliness of the information.

In some aspects, the techniques described herein relate to a non-transitory computer-readable storage medium, the computer-readable storage medium including instructions that when executed by a device, cause the device to: obtain purchase history data for a plurality of users within a group, the purchase history corresponding to at least one product; determine a first product availability corresponding to the at least one product based on the purchase history data; transmit, to a User Equipment (UE) of a user of the plurality of users, a notification including the first product availability; obtain updated purchase history data, the updated purchase history data corresponding to the at least one product; determine a second product availability corresponding to the at least one product based on the updated purchase history data; determine a product availability change based on the first product availability and the second product availability; and modify user rights of the user based on the product availability change.

In some aspects, the techniques described herein relate to a device comprising a processor configured to: obtain purchase history data for a plurality of users within a group, the purchase history corresponding to at least one product; determine a first product availability corresponding to the at least one product based on the purchase history data; transmit, to a User Equipment (UE) of a user of the plurality of users, a notification including the first product availability; obtain updated purchase history data, the updated purchase history data corresponding to the at least one product; determine a second product availability corresponding to the at least one product based on the updated purchase history data; determine a product availability change based on the first product availability and the second product availability; and modify user rights of the user based on the product availability change.

Various details regarding the aforementioned embodiments are described herein.

FIG. 1 is a block diagram illustrating components of a notification system according to some embodiments.

According to some embodiments, system 100 can include product availability engine 102, network 112, and database 114. In some embodiments, product availability engine 102 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, product availability engine 102 can be a stand-alone application that executes on a computing device (e.g., device 400 from FIG. 4). In some embodiments, product availability engine 102 can function as an application installed on the computing device, and in some embodiments, such application can be a web-based application accessed by the computing device over a network. In some embodiments, portions of the product availability engine 102 function as an application installed on the computing device and some other portions can be cloud-based or web-based applications accessed by the computing device over a network, where the several portions of the product availability engine 102 exchange information over the network. In some embodiments, the product availability engine 102 can be installed as an augmenting script, program or application (e.g., a plug-in or extension) to another application or portable data structure.

In some embodiments, the database 114 can be any type of database or memory, and can be associated with a content server or an application server on a network or a computing device. In some embodiments, database 114 can include a dataset of data and metadata associated with users, applications, requests, and the like. In some embodiments, database 114 can include a dataset of data and metadata associated with products, purchases, vendors, suppliers, services, and the like.

In some embodiments, database 114 can include user data. In some embodiments, user data can include a user ID, a password, one or more social groups to which the user belongs, contact information (e.g., address, phone number, and the like), payment methods, alert methods (e.g., call, message), and purchase history. In some embodiments, purchase history for a specific user can be gathered from user communications (e.g., messages, emails, phone calls), from third-parties (e.g., stores or data brokers), and from the user's bank or credit card statements.

In some embodiments, database 114 can include report data corresponding to a report associated with one or more products. In some embodiments, report data can include data and metadata such as a report type (e.g., purchase, availability report, absence report), a report time (e.g., when an observation was made), a timestamp (e.g., when an observation was entered into the availability system), a location (e.g., a geographical location or business location), a user ID, a product ID, a product amount, and a product price.

In some embodiments, database 114 can include standing query data corresponding to a query submitted by a user to be notified of the availability of a product based on a set of query parameters. In some embodiments, standing query data or query parameters can include a query ID (e.g., a unique identifier assigned to the query), a user ID (e.g., of the user submitting the query), product information (e.g., product IDs, category IDs, or a combination thereof), group IDs, and a geographical locations.

In some embodiments, database 114 can include product data corresponding to a product. In some embodiments, product data can include a product ID (e.g., a unique identifier assigned to a product or an instance of a product), a product name, a product description, and a category ID.

In some embodiments, database 114 can include category data corresponding to one or more categories characterizing products. In some embodiments, product categories can be hierarchical. That is, in some embodiments, a category may be a subcategory of a broader category (e.g., trucks as a subcategory of automobiles) and/or it may be a supercategory covering a plurality of categories (e.g., home decor may cover furniture, appliances, housewares, etc.). In some embodiments, category data can include a category ID (e.g., a unique identifier assigned to a category), category description, product IDs (e.g., corresponding to the products that fall within a given category), supercategory IDs, and subcategory IDs.

In some embodiments, database 114 can include availability data corresponding to the availability of a given product within a geographic area and social group. In some embodiments, availability data can include, per product ID, location, and group ID; an amount (where a value of “0” includes an absence of the product at the location) and a price.

In some embodiments, database 114 can include predicted availability data corresponding to a prediction indicating the potential availability of a given product within a geographic area and social group. In some embodiments, the predicted availability data can include, per product ID, location, and group ID; a predicted amount, a predicted price, a predicted timeframe or time period indicating the start and end times or period frequency, respectively, when the product will be available, and a prediction confidence score.

In some embodiments, user data, report data, standing query data, product data, category data, availability data, and predicted availability data can be stored and indexed in the database 114 independently and/or as a linked or associated dataset (e.g., using unique identifiers).

According to some embodiments, database 114 may store data and metadata associated with users, products, messages, images, videos, text, documents, items and services from an assortment of media, applications and/or service providers and/or platforms, and the like. Accordingly, any other type of known or to be known attribute or feature associated with a user, product, location, request, data item, media item, website, application, communication (e.g., a message) and/or its transmission over a network, an entity and/or content included therein, or some combination thereof, can be saved as part of the data/metadata in database 114.

According to some embodiments, network 112 can be any type of network such as, but not limited to, a wireless network, a local area network (LAN), wide area network (WAN), the Internet, or a combination thereof. In some embodiments, network 112 may facilitate connectivity of the product availability engine 102, and the database 114. Indeed, as illustrated in FIG. 1, the product availability engine 102 and database 114 can be directly connected by any known or to be known method of connecting and/or enabling communication between such devices and resources.

The principal processor, server, or combination of devices that comprise hardware programmed in accordance with the special purpose functions herein is referred to for convenience as product availability engine 102, and includes data module 104, user management module 106, prediction/computation module 108, and notification module 110. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

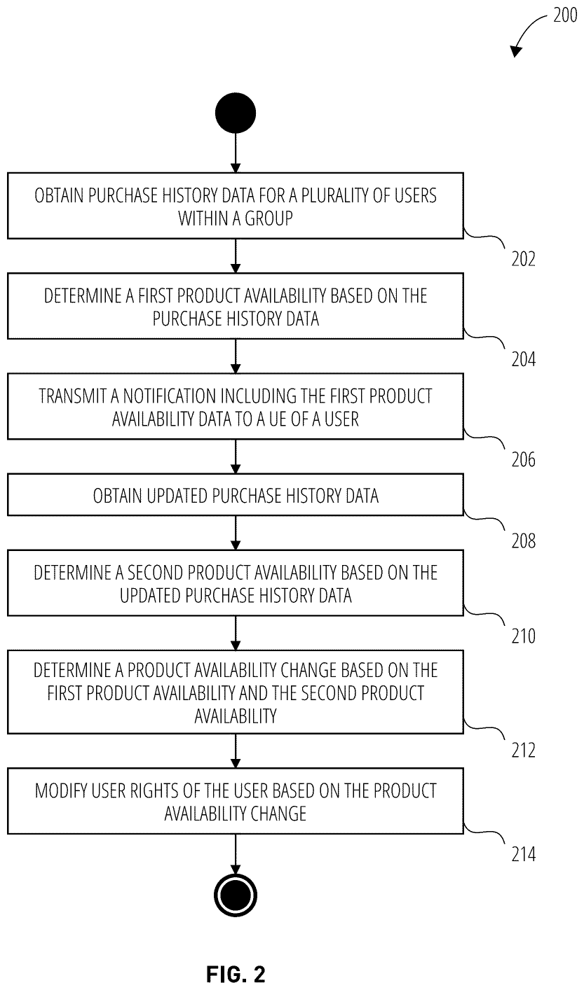

FIG. 2 is a flow diagram illustrating a method for managing user rights in a social network platform according to some embodiments.

According to some embodiments, method 200 can be performed by product availability engine 102. In some embodiments, Steps 202 and 208 can be performed by data module 104, Steps 204, 210, and 212 can be performed by prediction/computation module 108, Step 206 can be performed by notification module 110 and Step 214 can be performed by user management module 106.

In Step 202, method 200 can include obtaining purchase history data for a plurality of users within a group of a social media platform. In some embodiments, the purchase history can correspond to at least one product. In some embodiments, purchase history data can include a product ID, product quantity, vendor, among others. In some embodiments, product availability engine 102 can retrieve the product history data and any other data needed from database 114. In some embodiments, obtaining purchase history data can include obtaining report data and product availability delta records corresponding to product availability of the at least one product.

In Step 204, method 200 can include determining a first product availability corresponding to the at least one product based on purchase history data and/or other product availability data. In some embodiments, first product availability can include product availability data such as a product ID, product quantity, vendor, and location.

In some embodiments, product availability can be determined or predicted using statistical modeling. In some embodiments, statistical models can be used to predict periods of time when products will be available at specific vendors. In some embodiments, the statistical models can take historical purchase data, historical product availability data, or any other relevant data (e.g., report data) and output predicted time periods of future availability. In some embodiments, product availability predictions can have associated confidence scores. In some embodiments, the models may use averages from historical data to predict the time period for which a product is unavailable at a location based on the average of such time periods in the past, or as a weighted average that emphasizes more recent outages over less recent ones. In some embodiments, the model can also use historical dates and times when a product became available to detect whether that follows a pattern at a location, for example whether a product tends to become available on a given time period (e.g., some day of the week) at a given vendor or vendor location.

In some embodiments, if there is insufficient data to predict availability of a single product at a single location, then multiple products and locations can be modeled in aggregate, for example using a tree model. In some embodiments, product availability predictions can be stored as predicted availability data in database 114. In some embodiments, the predicted availability data can be separated by user groups, so that each group's data is used to build that group's predictions about product availability.

In some embodiments, a response to a query for a product in an area may be generated from the predicted availability data in addition to the availability data. In some embodiments, query results from both sets of data may be combined for display to a user, offering information about immediate availability in some locations and predicted future availability in others.

In Step 206, method 200 can include transmitting, to a UE of a user of the plurality of users, a notification including the first product availability data. In some embodiments, the notification may be transmitted by message, email, or phone call. In some embodiments, the method of communicating notifications to the user can be predetermined by user-provided notification preferences in a social network platform.

In Step 208, method 200 can include obtaining updated purchase history data, the updated purchase history data corresponding to the at least one product. In some embodiments, Step 208 can include obtaining report data and/or product availability delta report data.

In Step 210, method 200 can include determining a second product availability corresponding to the at least one product based on the updated purchase history data. In some embodiments, second product availability can include product availability data such as a product ID, product quantity, vendor, and location.

In Step 212, method 200 can include determining a product availability change based on the first product availability and the second product availability. In some embodiments, determining a product availability change can include determining whether there is a change in product quantity (e.g., a shortage or an overage) or a change in price.

In Step 214, method 200 can include modifying user rights of the at least one user based on the product availability change. In some embodiments, the user rights can correspond to a user's capabilities within the social network platform. In some embodiments, the user rights can correspond to the user's ability to share and/or receive information within the group. In some embodiments, modifying the user rights can include restricting the user rights. In some embodiments, modifying the user rights can include expanding the user rights.

In some embodiments, modifying the user rights can be based on an information usefulness score corresponding to the user. In some embodiments, users with the higher the usefulness score are granted more access and rights to receive and share information. In some embodiments, the information usefulness score can be based on the amount of information the user shares as compared to other users in the respective group. In some embodiments, the information usefulness score can be based on the utility of the information. That is, in some embodiments, information usefulness score can be based whether information on product availability reported by a user is followed by purchases of the product at the location by fellow group members and on how soon after the information is shared the product becomes unavailable. In some embodiments, the information usefulness score can be based on how similar the information shared by the user is to information shared by other users (e.g., how accurate the user's information is). In some embodiments, the information usefulness score can be based on timeliness of the information (e.g., how does the user's timing in sharing the information compared to others). In those embodiments, users who report information earlier are rewarded with increased usefulness scores and thus increased rights.

In some embodiments, modifying the user rights can include enforcing limits on capabilities such as, by way of non-limiting examples: the user's ability to share and/or receive information; the number of queries and/or standing queries a user can submit within a time period; and/or the number of responsive results to the user's queries. In some embodiments, limiting the user rights can be based on the information usefulness score. In some embodiments, modifying user rights can include expanding limits imposed on the user's capabilities. In some embodiments, expanding user rights or capabilities can include, by way of non-limiting examples: allowing users to receive advance or early notification of product availability changes, allowing users to join additional groups such as groups outside a geographic area, and/or allowing users to receive incentives such as coupons, early access to products, and/or other rewards. In some embodiments, expanding user rights can be based on the information usefulness score. In this way, via modification of rights, posts or shares or messages or searches that might exacerbate or even create shortages or other market disequilibrium can be managed or controlled.

FIG. 3 is a block diagram illustrating an example of a network within which the systems and methods disclosed herein could be implemented according to some embodiments.

FIG. 3 shows components of a general environment in which the systems and methods discussed herein may be practiced. Not all the components may be required to practice the disclosure, and variations in the arrangement and type of the components may be made without departing from the spirit or scope of the disclosure.

FIG. 3 illustrates a system 300 in accordance with an embodiment of the present disclosure is shown. As shown, system 300 can include local area networks (“LANs”)/wide area networks (“WANs”)-network 310, wireless network 312, mobile devices (client device) 304-308 and client device 302. System 300 can also include a variety of servers, such as application (“App”) server 314, platform server 316, and messaging server 320.

One embodiment of mobile devices 304-308 is described in more detail below. Generally, however, mobile devices 304-308 can include virtually any portable computing device capable of receiving and sending a message over a network, such as network 310, wireless network 312, or the like. In some embodiments, mobile devices 304-308 can also be described generally as client devices that are configured to be portable.

Mobile devices 304-308 can also include at least one client application that is configured to receive content from another computing device. In some embodiments, the client application can include a capability to provide and receive textual content, graphical content, audio content, and the like. In some embodiments, the client application can further provide information that identifies itself, including a type, capability, name, and the like. In one embodiment, mobile devices 304-308 may uniquely identify themselves through any of a variety of mechanisms, including a phone number, Mobile Identification Number (MIN), an electronic serial number (ESN), or other mobile device identifier.

In some embodiments, mobile devices 304-308 can also communicate with non-mobile client devices, such as client device 302, or the like. In some embodiments, client device 302 may include virtually any computing device capable of communicating over a network to send and receive information.

In some embodiments, devices 302-308 can be referred to as computing devices. Devices 302-308 may be capable of sending or receiving signals, such as via a wired or wireless network, or may be capable of processing or storing signals, such as in memory as physical memory states, and may, therefore, operate as a server. Computing devices may, for example, include portable, non-portable, and wearable devices (e.g., desktop computers, cellular phones, smart watches, and tablets).

Wireless network 312 can be configured to couple mobile devices 304-308 and its components with network 310. Wireless network 312 can include any of a variety of wireless sub-networks that may further overlay stand-alone ad-hoc networks, and the like, to provide an infrastructure-oriented connection for mobile devices 304-308. Such sub networks can include mesh networks, Wireless LAN (WLAN) networks, cellular networks, and the like. In some embodiments, a wireless network may include virtually any type of wireless communication mechanism by which signals may be communicated between computing devices.

Network 310 is configured to couple App server 314, platform server 316, messaging server 320, or the like, with other computing devices, including, client device 302, and through wireless network 312 to mobile devices 304-308. Network 310 is enabled to employ any form of computer readable media or network for communicating information from one electronic device to another. Also, network 310 can include the Internet in addition to local area networks (LANs), wide area networks (WANs), or direct connections. According to some embodiments, a “network” should be understood to refer to a network that may couple devices so that communications may be exchanged (e.g., between a server and a client device) including between wireless devices coupled via a wireless network, for example. A network may also include mass storage or other forms of computer or machine readable media, for example.

In some embodiments, the disclosed networks 310 and/or 312 can comprise a content distribution network(s). A “content delivery network” or “content distribution network” (CDN) generally refers to a distributed content delivery system that comprises a collection of computers or computing devices linked by a network or networks.

In some embodiments, the platform server 316, and/or messaging server 320 can include a device that includes a configuration to provide any type or form of content via a network to another device. Servers 316, and 320 can further provide a variety of services that include, but are not limited to, email services, instant messaging (IM) services, streaming and/or downloading media services, search services, photo services, web services, social networking services, news services, third-party services, audio services, video services, mobile application services, or the like. Such services, for can be provided via the App server 314, whereby a user is able to utilize such service upon the user being authenticated, verified or identified by the service. In some embodiments, App server 314, platform server 316, 320 can store, obtain, retrieve, or provide purchase data, user data, report data, query data, and other types of data as discussed herein.

Servers 314, 316, and 320 may be capable of sending or receiving signals, such as via a wired or wireless network, or may be capable of processing or storing signals, such as in memory as physical memory states. According to some embodiments, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

Devices capable of operating as a server may include, as examples, dedicated rack-mounted servers, desktop computers, laptop computers, set top boxes, integrated devices combining various features, such as two or more features of the foregoing devices, or the like.

In some embodiments, users are able to access services provided by servers 314, 316, and/or 320 via the network 310 and/or wireless network 312 using their various devices 302-308.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), search applications (e.g., Yahoo!® Search), and the like, can be hosted by the App server 314, platform server 316, and the like.

Thus, the App server 314, for example, can store various types of applications and application related information including application data and user profile information (e.g., identifying and behavioral information associated with a user). It should also be understood that platform server 316 can also store various types of data related to the content and services provided by platform server 316 in an associated database 318, as discussed in more detail herein, for example, in relation to database 114.

In some embodiments, platform server 316 (in some embodiments, an “ad server”) can comprise a server that stores online advertisements for presentation to users. “Ad serving” refers to methods used to place online advertisements on websites, in applications, or other places where users are more likely to see them, such as during an online session or during computing platform use, for example. In some embodiments, platform server 316 can incorporate near instantaneous auctions of ad placement opportunities during web page creation.

Moreover, although FIG. 3 illustrates servers 314, 316, and 320 as single computing devices, respectively, the disclosure is not so limited. For example, one or more functions of servers 314, 316, and/or 320 can be distributed across one or more distinct computing devices. Moreover, in one embodiment, servers 314, 316, and/or 320 can be integrated into a single computing device, without departing from the scope of the present disclosure.

FIG. 4 is a block diagram of a device according to some embodiments.

As illustrated, the device 400 can include a processor or central processing unit (CPU) such as CPU 402 in communication with a memory 404 via a bus 414. The device can also include one or more input/output (I/O) or peripheral devices 412. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 402 can comprise a general-purpose CPU. The CPU 402 can comprise a single-core or multiple-core CPU. The CPU 402 can comprise a system-on-a-chip (SoC) or a similar embedded system. In some embodiments, a graphics processing unit (GPU) can be used in place of, or in combination with, a CPU 402. Memory 404 can comprise a non-transitory memory system including a dynamic random-access memory (DRAM), static random-access memory (SRAM), Flash (e.g., NAND Flash), or combinations thereof. In one embodiment, the bus 414 can comprise a Peripheral Component Interconnect Express (PCIe) bus. In some embodiments, bus 414 can comprise multiple busses instead of a single bus.

Memory 404 illustrates an example of non-transitory computer storage media for the storage of information such as computer-readable instructions, data structures, program modules, or other data. Memory 404 can store a basic input/output system (BIOS) in read-only memory (ROM), such as ROM 408, for controlling the low-level operation of the device. The memory can also store an operating system in random-access memory (RAM) for controlling the operation of the device.

Applications 410 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 406 by CPU 402. CPU 402 may then read the software or data from RAM 406, process them, and store them in RAM 406 again.

The device 400 can optionally communicate with a base station (not shown) or directly with another computing device. One or more network interfaces in peripheral devices 412 are sometimes referred to as a transceiver, transceiving device, or network interface card (NIC).

An audio interface in Peripheral devices 412 produces and receives audio signals such as the sound of a human voice. For example, an audio interface may be coupled to a speaker and microphone (not shown) to enable telecommunication with others or generate an audio acknowledgment for some action. Displays in Peripheral devices 412 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 412 can comprise any input device arranged to receive input from a user. An illuminator in peripheral devices 412 can provide a status indication or provide light. The device can also comprise an input/output interface in peripheral devices 412 for communication with external devices, using communication technologies, such as USB, infrared, Bluetooth™, or the like. A haptic interface in peripheral devices 412 can provide a tactile feedback to a user of the client device.

A GPS receiver in peripheral devices 412 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 4, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
obtaining purchase history data for a plurality of users within a group, the purchase history corresponding to at least one product;
determining a first product availability corresponding to the at least one product based on the purchase history data;
transmitting, to a User Equipment (UE) of a user of the plurality of users, a notification including the first product availability;
obtaining updated purchase history data, the updated purchase history data corresponding to the at least one product;
determining a second product availability corresponding to the at least one product based on the updated purchase history data;
determine a product availability change based on the first product availability and the second product availability; and
modifying user rights of the user based on the product availability change.

2. The method of claim 1, wherein obtaining updated purchase history data further comprises obtaining report data corresponding to product availability of the at least one product.

3. The method of claim 2, wherein determining the second product availability is based on the updated purchase history data and the report data.

4. The method of claim 1, wherein the user rights correspond to a user's ability to share information within the group.

5. The method of claim 1, wherein modifying the user rights comprises limiting a capability selected from the group consisting of a user's ability to share and receive information, a number of queries and standing queries a user can submit within a time period, and a number of responsive results to user's queries.

6. The method of claim 1, wherein modifying the user rights is further based on an information usefulness score corresponding to the user.

7. The method of claim 6, wherein the information usefulness score is based on whether the user shares more or less product availability information than other users from the plurality of users, the utility of the information, similarity to information shared by other users, and timeliness of the information.

8. A non-transitory computer-readable storage medium, the computer-readable storage medium including instructions that when executed by a device, cause the device to:
obtain purchase history data for a plurality of users within a group, the purchase history corresponding to at least one product;
determine a first product availability corresponding to the at least one product based on the purchase history data;
transmit, to a User Equipment (UE) of a user of the plurality of users, a notification including the first product availability;
obtain updated purchase history data, the updated purchase history data corresponding to the at least one product;
determine a second product availability corresponding to the at least one product based on the updated purchase history data;
determine a product availability change based on the first product availability and the second product availability; and
modify user rights of the user based on the product availability change.

9. The computer-readable storage medium of claim 8, wherein obtaining updated purchase history data further comprises obtaining report data corresponding to product availability of the at least one product.

10. The computer-readable storage medium of claim 9, wherein determining the second product availability is based on the updated purchase history data and the report data.

11. The computer-readable storage medium of claim 8, wherein the user rights correspond to a user's ability to share information within the group.

12. The computer-readable storage medium of claim 8, wherein modifying the user rights comprises limiting a capability selected from the group consisting of a user's ability to share and receive information, a number of queries and standing queries a user can submit within a time period, and a number of responsive results to user's queries.

13. The computer-readable storage medium of claim 8, wherein modifying the user rights is further based on an information usefulness score corresponding to the user.

14. The computer-readable storage medium of claim 13, wherein the information usefulness score is based on whether the user shares more or less product availability information than other users from the plurality of users, the utility of the information, similarity to information shared by other users, and timeliness of the information.

15. A device comprising:
a processor configured to:
obtain purchase history data for a plurality of users within a group, the purchase history corresponding to at least one product;
determine a first product availability corresponding to the at least one product based on the purchase history data;
transmit, to a User Equipment (UE) of a user of the plurality of users, a notification including the first product availability;
obtain updated purchase history data, the updated purchase history data corresponding to the at least one product;
determine a second product availability corresponding to the at least one product based on the updated purchase history data;
determine a product availability change based on the first product availability and the second product availability; and
modify user rights of the user based on the product availability change.

16. The device of claim 15, wherein obtaining updated purchase history data further comprises obtaining report data corresponding to product availability of the at least one product.

17. The device of claim 16, wherein determining the second product availability is based on the updated purchase history data and the report data.

18. The device of claim 15, wherein the user rights correspond to a user's ability to share information within the group.

19. The device of claim 15, wherein modifying the user rights comprises limiting a capability selected from the group consisting of a user's ability to share and receive information, a number of queries and standing queries a user can submit within a time period, and a number of responsive results to user's queries.

20. The device of claim 15, wherein modifying the user rights is further based on an information usefulness score corresponding to the user, and wherein the information usefulness score is based on whether the user shares more or less product availability information than other users from the plurality of users, the utility of the information, similarity to information shared by other users, and timeliness of the information.
